(19) United States
(12) Patent Application Publication
(10) Pub. No.: US 2012/0081929 A1
(43) Pub. Date: Apr. 5, 2012

(54) High Efficiency and Low Cost High Voltage Power Converter

(75) Inventor: James E. Dvorsky, Hilliard, OH (US)

(73) Assignee: BATTELLE MEMORIAL INSTITUTE, Columbus, OH (US)

(21) Appl. No.: 13/313,457

(22) Filed: Dec. 7, 2011

Related U.S. Application Data
(63) Continuation-in-part of application No. PCT/US2010/037899, filed on Jun. 9, 2010.
(60) Provisional application No. 61/185,467, filed on Jun. 9, 2009.

(51) Int. Cl. H02M 3/335

(52) U.S. Cl. 363/21.12

(57) ABSTRACT

A low cost, high efficiency, high voltage DC to DC power converter that operates from batteries to provide support to products using Electric Field Effect Technology to generate aerosols.

This application is a Continuation-in-Part of International Application PCT/US2010/037899 filed Jun. 9, 2010, 2002 which designated the U.S. The International Application was published in English under PCT Article 21(2) on Dec. 16, 2010 as International Publication Number WO 2010/144528 and republished on Feb. 3, 2011 under the same International Publication Number. PCT/US2010/037899 claims priority to U.S. Provisional Application No. 61/185,467, filed Jun. 9, 2009. Thus, the subject nonprovisional application claims priority to U.S. Provisional Application No. 61/185,467, filed Jun. 9, 2009. The disclosures of both applications are incorporated herein by reference.

### BACKGROUND OF THE INVENTION

This invention relates in general to Electric Field Effect Technology for generating aerosols and in particular to a high voltage power converter that operates from batteries.

Electric Field Effect Technology (EFET) has been demonstrated as an effective means of producing fine droplet aerosols with a number of unique and desirable characteristics. The technology relies on the application of a high voltage (low power) to a fluid in order to induce comminution. For many commercial applications, portability of the product generating the aerosol, as well as device cost and operating efficiency are critical to the commercial success of devices employing EFET.

One of the significant hurdles for EFET is that available power supplies for EFET devices do not presently meet all of the requirements established for a high voltage converter to support portable EFET operations. Currently available high voltage power supplies that are required for EFET devices tend to provide inconsistent output voltage which is inefficient and wasteful. Among currently available high voltage power supplies for EFET devices are flyback converters that are well-suited to creating high voltages with a relatively simple circuit architecture. However, these converters are ideally applied to applications where the load current is substantially larger than the current needed to operate the supply. Conversely, the “load” associated with EFET spraying is often miniscule and considerably smaller than the operating current of the supply. As a result, the input-output power efficiency may be less than three percent (3%) when driving an EFET device as compared to 30 to 40% when sourcing a full load. Moreover, the output voltage of many commercially available high voltage converters varies as a function of input voltage, an undesirable behavior when the device is portable and powered from batteries and a constant output voltage is desired. It is well-known that the terminal voltage of batteries declines over time as their energy is extracted. Therefore, it is desirable to provide a high efficiency, low cost high voltage power converter for use with EFET that can be powered from a changing voltage source yet yield a consistent output.

### SUMMARY OF THE INVENTION

This invention relates to a high voltage power converter that operates from small alkaline batteries.

The present invention contemplates a high voltage power converter that has an electronic switch having an input port adapted to be connected to a power supply, the electronic switch also including an output port and a control port. The output port of the switch is connected to the primary winding of a flyback transformer that has a secondary winding connected to an input port of a voltage multiplier circuit. The voltage multiplier circuit also has an output port adapted to be connected to an electrical load. Additionally, the supply Includes a controller for the electronic switch. The controller is operative to cause the electronic switch to alternate between conducting and non-conducting states to supply an initial amount of energy to the flyback transformer and subsequently to the voltage multiplier. The controller is further operative, as a function of an operating parameter of the converter, to again cause the electronic switch to enter the conducting state to supply additional energy to the flyback transformer and subsequently to the voltage multiplier. Various objects and advantages of this invention will become apparent to those skilled in the art from the following detailed description of the invention, when read in light of the accompanying drawings.

### BRIEF DESCRIPTION OF THE DRAWINGS

FIG. 1 is a block diagram of a high voltage power converter that is in accordance with the present invention.

FIG. 2 illustrates an internal power waveform generated within the present invention.

FIG. 3 illustrates an output power waveform from the present invention that corresponds to the internal power waveform shown in FIG. 2.

FIG. 4 is a circuit diagram illustrating the operation of a voltage regulator circuit that is utilized in the present invention.

FIG. 5 is a circuit diagram for the high voltage power converter shown in FIG. 1.

FIG. 6 is a flow chart that illustrates the operation of the high voltage power supply shown in FIG. 1.

FIG. 7 is a block diagram of an alternate embodiment of the high voltage power converter shown in FIG. 1.

FIG. 8 is a block diagram of another alternate embodiment of the high voltage power converter shown in FIG. 1.

### DETAILED DESCRIPTION OF THE PREFERRED EMBODIMENT

The present invention is directed toward a high voltage power converter for an Electric Field Effect Technology (EFET) platform. The high voltage power converter would be utilized in a hand-held sprayer and is designed to deliver an output voltage in the range of 20 kV to 25 kV, although other output voltage ranges also may be provide, with an input voltage within a nominal range of 4-6 VDC. Thus, the converter may be powered by small light-weight batteries, such as, for example, a series connection of three or four AA alkaline batteries. This same device is also able to generate 10-12 kV while operating from 2-3 VDC at its input, but its operating life before needing to replace the batteries providing the input power would be significantly reduced to hours rather than days.

The present invention is directed toward a high voltage power converter for an Electric Field Effect Technology (EFET) platform. The high voltage power converter would be utilized in a hand-held sprayer and is designed to deliver an output voltage in the range of 20 kV to 25 kV, although other output voltage ranges also may be provided, with an input voltage within a nominal range of 4-6 VDC. Thus, the converter may be powered by small light-weight batteries, such as, for example, a series connection of three or four AA alkaline batteries. This same device is also able to generate 10-12 kV while operating from 2-3 VDC at its input. The increased operating efficiency of both devices is expected to greatly extend the life of the batteries powering the devices. In contrast, the operating life of commercially available devices before needing to replace the batteries providing the input power would be significantly reduced to hours rather than days as required of a practical EFET-based product.

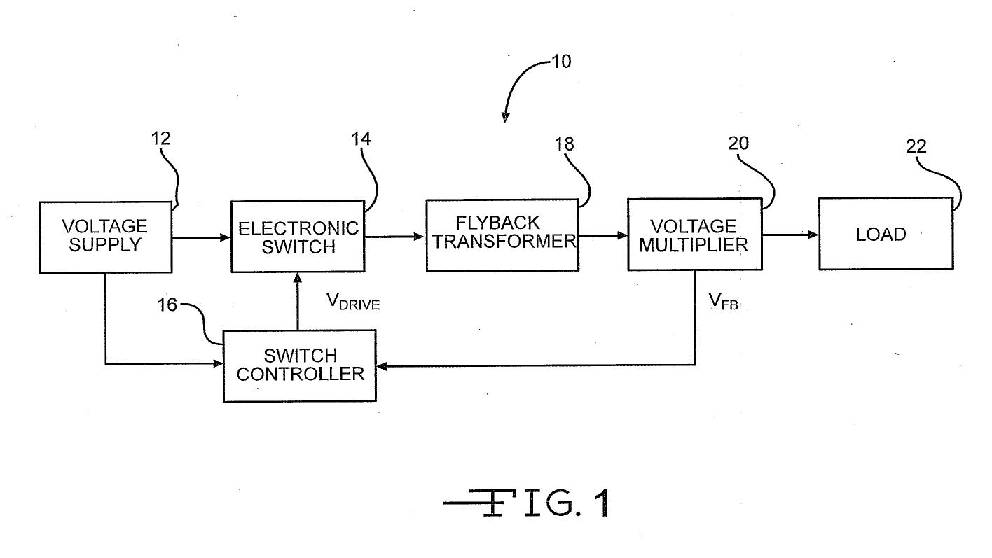

Referring now to FIG. 1, there is shown a block diagram of a first embodiment of a high voltage power converter 10 in accordance with the present invention. A low voltage DC supply 12 provides input power to a switching circuit 14 and a switch controller 16, which will be more fully described below. As described above, in the first embodiment, the power supply 12 consists of a plurality of small batteries, such as, for example, two to four AA alkaline storage batteries or two to four rechargeable batteries. The output of the switching circuit 18 is connected to the primary winding of a flyback transformer 18, which raises the applied voltage to a higher value. The secondary of the flyback transformer 18 is connected to the input of a voltage multiplier circuit 20 that has an output connected to a load 22. As will also be explained below, a feedback voltage V_{FB} obtained from the voltage multiplier circuit 20 is applied to a feedback port on the switch controller 16.

Referring now to FIG. 1, there is shown a block diagram of a first embodiment of a high voltage power converter 10 in accordance with the present invention. A low voltage DC supply 12 provides input power to a switching circuit 14 and a switch controller 16, which will be more fully described below. As described above, in the first embodiment, the power supply 12 consists of a plurality of small batteries, such as, for example, two to four AA alkaline storage batteries or two to four rechargeable nickel hydride batteries. The output of the switching circuit 18 is connected to the primary winding of a flyback transformer 18, which raises the applied voltage to a higher value. The secondary of the flyback transformer 18 is connected to the input of a voltage multiplier circuit 20 that has an output connected to a load 22. As will also be explained below, a feedback voltage V_{FB} obtained from the voltage multiplier circuit 20 is applied to a feedback port on the switch controller 16.

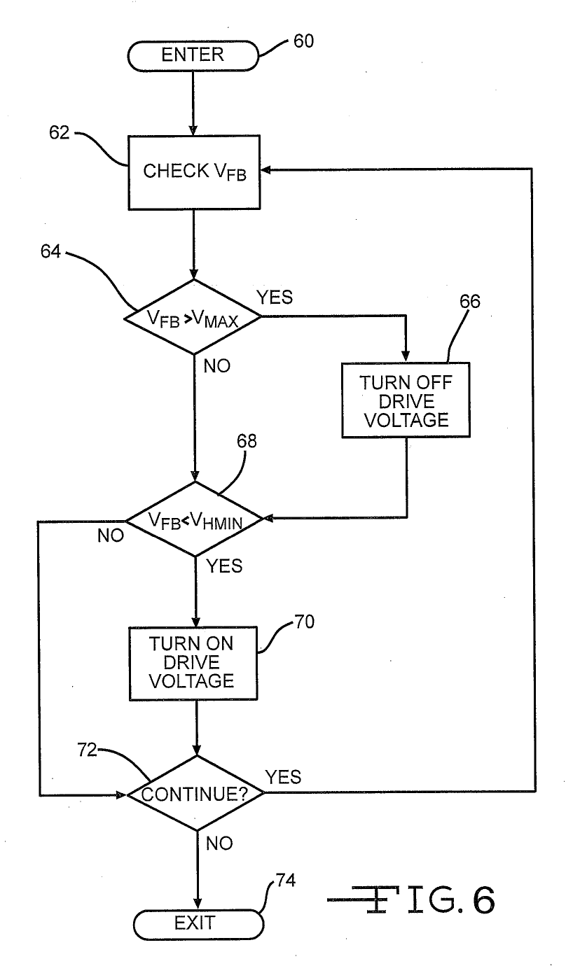

The voltage multiplier circuit 20 output that consists of a multiple stage array of diodes and capacitors that effectively increase the peak output voltage from the transformer by ten-fold. While a five stage voltage multiplier array is shown in FIG. 5, it will be appreciated that more or less than five stages may be used to obtain a desired output, but there are practical limitations to the maximum number of stages. The capacitors in the voltage multiplier circuit 20 hold a sufficient charge to allow an EFET device, such as an EFET sprayer, to continue spraying for a period of time after input power to the converter has been removed. Since the amount of time needed to charge the capacitors is much less than the time to discharge them, the duty cycle of the input voltage can be significantly reduced with a corresponding reduction in input power.

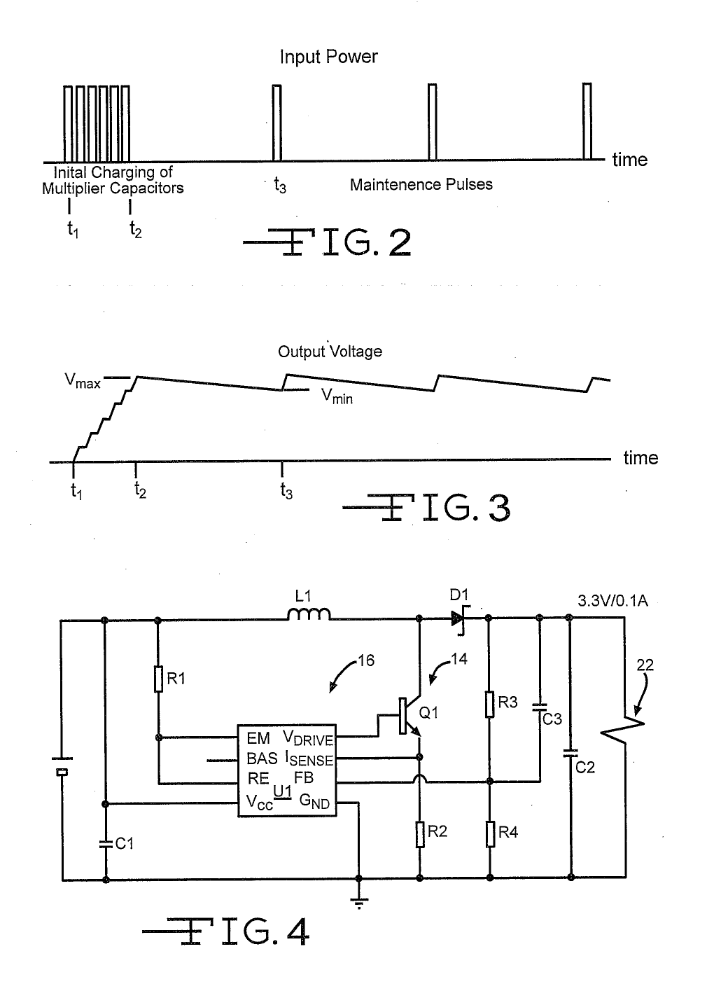

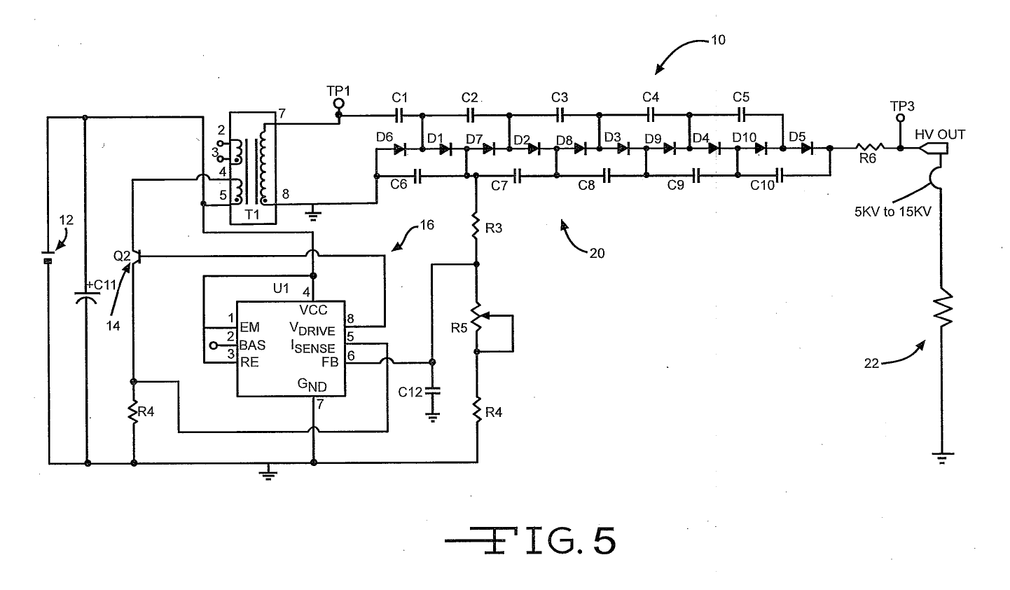

Most of the power savings is obtained from the energy drawn by the converter itself. Known power converters typically are self oscillating and always operating, somewhat independent of the load current drawn from the supply. Furthermore, it has been observed that the conversion losses with known power converters are much greater than the load power, especially for lightly loaded supplies, leading to very inefficient energy conversion. Accordingly, the present invention focuses on reducing the operational losses so that the power supplied by the source, i.e., the battery, is more efficiently delivered to the load (EFET sprayer). To accomplish this, the architecture of a conventional converter was modified. Instead of a continuously self-oscillating architecture, which produces sinusoidal signals, the configuration of a flyback converter is utilized. Thus, the present invention stores energy in the transformer during part of the operating cycle and releases it to the output during another part. The power converter 10 contemplated by the present invention is a converter that quickly charges the magnetic core in the flyback transformer 18, discharges the energy to the voltage multiplier circuit 20 according to the current draw of the capacitors, and then coasts for a period of time while the load 22 draws energy from the voltage multiplier. Initially, the converter 10 would be expected to have several cycles of energy transfer to and from the transformer 18, but over time, the need for continuous energy flow would fall as only the EFET load is supplied. Then, the converter 10 would draw energy from its source 12 on an as-needed basis. The timing of power input to the converter 10 may appear as shown in FIG. 2 while the corresponding output is shown in FIG. 3.

After considering a number of approaches, including the use of low duty cycle timers, the inventor determined that a voltage regulating circuit could be utilized in the converter for the switch controller 16. A commercially available Zetex ZXSC100 voltage regulator U1 has both a pulse-width modulation (PWM) and pulse frequency modulation (PFM) operating modes with the PFM mode specifically intended for low power applications. In addition, this component was selected for its ability to operate from 1-3V DC; hence, it is ideally suited for devices powered by two alkaline voltage cells. The regulator U1 includes a shutdown circuit that turns the device on and off The regulator U1 turns on when power is applied at t₁ in FIGS. 2 and 3 and generates a PFM voltage pulse train at a constant frequency that is applied to the base of the switching transistor Q1 that is included in the switching circuit 14 in FIG. 4, and switches the transistor between its conducting and non-conducting states.

FIG. 4 illustrates the basic circuit configuration utilized in the converter 10 in which an inductor L1 has been connected to a switching transistor Q1 controlled by a non-synchronous PFM DC to DC controller Integrated Circuit (IC) which is labeled U1. In the embodiment shown in FIG. 4, a Zetex Semiconductor controller, ZXSC100, was utilized for U1; however, the invention also may be practiced with other similar commercially available devices. The base of the transistor Q1 is connected to a drive voltage port labeled V_{DRIVE} of U1. As the transistor Q1 conducts, current is drawn through the inductor L1 which stores energy. The output of the inductor L1 is connected through a voltage rectifying Zener diode D1 to an output filtering capacitor C2 which, in turn, is connected to the load 22. Because the regulator U1 generates a series of pulses at the drive voltage port, as shown between t₁ and t₂ in FIG. 2, the transistor Q1 is switched between its conducting and non-conducting states to provide a series of input pluses to the inductor L1. A voltage divider consisting of a series connection of resistors R3 and R4 also is connected across the output of the inductor L1 and provides a feedback voltage V_{FB} to the port labeled FB on the regulator U1 that is proportional to the output voltage. When the voltage V_{FB} reaches a preset maximum voltage value of V_{MAX}, the shutdown circuit turns off the regulator U1, which is shown as occurring at t₂ in FIGS. 2 and 3.

The shutdown circuit includes a built in hysteresis to prevent uncontrolled oscillations by not allowing the regulator U1 to turn back on until the output voltage drops to a value that is less than the maximum voltage value of V_{MAX}. This lower hysteresis related turn on voltage provides a minimum voltage value, V_{MIN} for operation of the converter 10. Thus, the regulator will turn on again when the output voltage has decayed to a value corresponding to V_{MIN,} as shown at t₃ in FIGS. 2 and 3. When the regulator U1 is again turned on the inductor L1 again draws energy from the supply 12. This hysteresis produces the time delay in the operation of the converter 10 illustrated in FIGS. 2 and 3 between t₂ and t₃.

The regulator U1 also includes a current monitoring port labeled I_{SENSE} that is connected to the high side of a feedback resistor R2. The voltage appearing across the feedback resistor R2 is proportional to the current flowing through the transistor Q1. If the voltage appearing across the resistor R2 exceeds a predetermined threshold the regulator U1 shuts off the drive voltage V_{DRIVE}, shutting down the converter 10. Thus the converter also is provided with over-current protection.

A circuit for a high voltage converter 10 that is in accordance with the present invention is illustrated in FIG. 5 where components that are similar to components shown in FIG. 4 have the same labels. As shown in FIG. 5, the circuit shown in FIG. 4 has been modified to implement the present invention by using a flyback transformer 18 and a five stage voltage multiplier circuit 20. The flyback transformer (FBT), also called a Line Output Transformer' (LOPT), is a special transformer which is used to generate High Voltage (HV) signals at a relatively high frequency. The main difference between a flyback transformer and a regular transformer is that a flyback transformer is designed to store energy in its magnetic circuit, i.e., it functions like a pure inductor, whereas a regular transformer is designed to transfer energy from its primary to secondary and to minimize stored energy. A flyback transformer in its simplest form has current flowing either in its primary, or in its secondary, but not both at the same time. The reluctance of the magnetic circuit of a flyback transformer is usually much higher than that of a regular transformer. This is because of a carefully calculated air-gap for storing energy and because it is an inductor. Unlike mains transformers and audio transformers, a LOPT is designed not just to transfer energy, but also to store it for a significant fraction of the switching period. This is achieved by winding the coils on a ferrite core with an air gap. The air gap increases the reluctance of the magnetic circuit and therefore its capacity to store energy

The circuit shown in FIG. 5 also includes a switching transistor Q2 connected between the flyback transformer secondary and the voltage multiplier circuit 20. The switching transistor Q2 is selected for its current carrying capacity and its low V_{ce}, saturation voltage to minimize losses in the transistor. The passive components in the circuit are configured to allow a peak primary current of 2.2 amperes and an output voltage range of 5 to 15 kV. The switching transistor Q2 may be either a bipolar junction transistor, as shown in FIGS. 4 and 5, or a field effect transistor with associated buffering circuitry (not shown)

The circuit shown in FIG. 5 also includes a switching transistor Q2 connected between a first terminal of the flyback transformer primary and ground. The second terminal of the flyback transformer primary is connected to the supply 12 while the base of the switching transistor Q2 is connected to the switch controller 16. The switching transistor Q2 is selected for its current carrying capacity and its low V_{ce}, saturation voltage to minimize losses in the transistor. The passive components in the circuit are configured to allow a peak primary current of 2.2 amperes and an output voltage range of 5 to 15 kV. The switching transistor Q2 may be either a bipolar junction transistor, as shown in FIGS. 4 and 5, or a Field Effect Transistor (FET) with associated buffering circuitry (not shown). If a FET is used for the switching transistor, the switch controller is connected to the FET gate.

Additionally, voltage feedback is provided from one of the first stages of the voltage multiplier circuit 20 and, in the first embodiment, includes a 500 Kohm variable resistor R5 for adjustment of V_{MAX}. Also, in the first embodiment, the other voltage divider resistors R3 and R4 have values of 1 Giga-ohm and 243 Kohm, respectively; however, the invention also may be practiced with other feedback voltage divider resistances. By tapping the first of the five multiplication stages of the voltage multiplier circuit 20, the feedback current and therefore the load on the converter 10 is minimized; but the true converter output voltage is not specifically regulated. However, the impact on operational power is significant. The present configuration is expected to draw up to 9 mW of power; however, if a similar resistive divider was placed at the output of the multiplier, with appropriate adjustment of resistances to compensate for the higher voltage, the power draw of the feedback circuit increases to 225 mW. Employing a feedback resistance greater than 1 Giga-ohm and capable of handling the higher output voltage increases the system cost dramatically. Therefore, the present configuration offers a reasonable compromise of performance, size and cost.

The transformer T1 is similar to that used in the self oscillating High Voltage Power Supply (HVPS), as described in U.S. patent application Ser. No. 12/306,100, which is incorporated herein by reference, but in the present configuration, the feedback winding is not employed and can be omitted from the transformer specification. Additionally, it is contemplated that the resistive feedback network of resistors R3, R4 and R5 may be replaced with a single resistor to set the output voltage to a specific value (not shown).

In the first embodiment, the voltage multiplier 20 includes a Cockcroft-Walton voltage multiplier consisting of a plurality of capacitor and diode stages connected in series. While a Cockcroft-Walton voltage multiplier is shown in FIG. 5, it will be appreciated that the invention also may be practiced with other conventional voltage multiplier circuits. When the capacitors of the voltage multiplier circuit 20 are initially uncharged and input power is applied to the converter 10, the converter is expected to operate at nearly 40 kHz, with an approximately nine microsecond conduction period, which corresponds to the width of the pulses shown in FIG. 2, and a 15 μsec discharge period, which corresponds to the distance between the pulses shown between t₁ and t₂ in FIG. 2. A mathematical model of the circuit operation predicts that the initial power draw from the batteries may be as high as 1.9 watts; however, the period over which this power is drawn, which is the time period between t₁ and t₂ in FIG. 2, is expected to be less than 1000 microseconds or one millisecond. For example, it has been found that about 40 on-off pulses were required to charge the capaciiors in a the voltage multiplier used in a prototype power convertor, which would require a charging time of approximately 960 microseconds. It will be noted that FIG. 2 is not drawn to scale, but is meant to be exemplary of the operation of the converter 10.

After the capacitors of the voltage multiplier circuit 20 are fully charged, the frequency of operation is expected to drop to less than 200 Hz. Thus, the time period between t₂ and t₃ in FIG. 2 is approximately 5 milliseconds. Since the conduction period is defined by the peak input current and the inductance of the primary winding, it will remain at nine microseconds, but the input power will drop to a few milliwatts. As a result, the inventor has found that, for the expected loads, only a single pulse of duration of approximately nine microseconds is needed to replace the energy in the flyback transformer 18. However, it will be appreciated the invention also may be practiced with a plurality of pulses be supplied to the flyback transformer beginning at t₃. At this power draw, a pair of AA alkaline batteries having a 2200 mA-hr capacity would be expected to operate over 600 hours or 25 days continuously. Hence, this architecture, or one similar to it, is expected to yield the operating longevity required of certain EFET spray devices.

The flyback configuration works well with Cockroft-Walton voltage multiplier (diodes and capacitors network) and can produce high voltages. However, the converter 10 also relies upon the voltage multiplier capacitors to sustain the output voltage over a period of time and the conduction time is limited to the point where the transformer core starts to saturate. Operating in saturation is of course inefficient because a greater portion of the input power is applied to wasteful heating of the transformer. A value of roughly nine microseconds worked well for the flyback transformer 18 and with an input voltage of up to six volts. Other transformers are likely to have slightly different input inductances and therefore have a different conduction period before saturation is reached. Certainly, higher input voltages will shorten the conduction time.

The inventor also explored different values of the capacitors used in the voltage multiplier 20 As expected, larger capacitors sustained the output voltage for longer periods of time but as capacitance increased, so do the leakage losses in the capacitors. The inventor found an optimum with 3300 picofarad ceramic capacitors, but certainly smaller and slightly larger capacitors also can be used. In designing voltage multiplier circuits it also must be born in mind that the voltage imposed across most of the capacitors is two times the peak voltage at the secondary winding of the transformer.

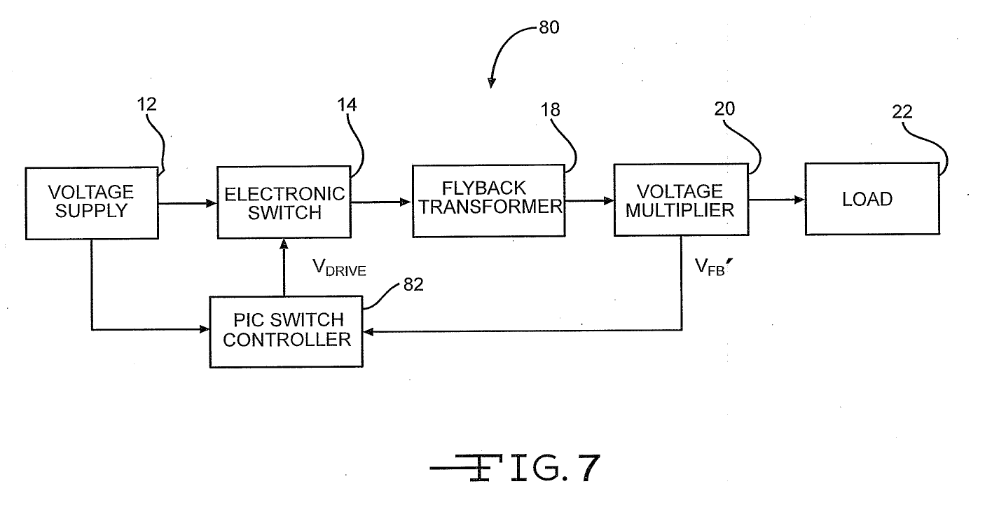

The operation of the present invention is illustrated by the flow chart shown in FIG. 6. The flow chart is entered through the block labeled 60 and proceeds to block 62 where the feedback voltage V_{FB} is sensed. The operation then advances to decision block 64 where the sensed feedback voltage V_{FB} is compared to the maximum output threshold voltage V_{MAX}. If the sensed feedback voltage V_{FB} is greater than the maximum output threshold voltage V_{MAX}, the operation transfers to functional block 66 where the drive voltage V_{DRIVE} is turned off. The operation then continues to decision block 68. If, in decision block 64, the sensed feedback voltage V_{FB} is less than, or equal to, the maximum output threshold voltage V_{MAX}, the operation transfers directly to decision block 68.

In decision block 68, the sensed feedback voltage V_{FB} is compared to a minimum regulator hysteresis voltage V_{HMIN} that corresponding to output voltage V_{MIN} shown in FIG. 3. If the sensed feedback voltage V_{FB} is less than the minimum minimum regulator hysteresis voltage V_{HMIN,} the operation transfers to functional block 70 where the drive voltage V_{DRIVE} is turned back on. The operation then continues to decision block 72. If, in decision block 68, the sensed feedback voltage V_{FB} is greater than, or equal to, the minimum regulator hysteresis voltage V_{HMIN}, the operation transfers directly to decision block 72.

In decision block 72, it is determined whether or not to continue operating the power converter. Such a decision may be made by consideration of any one or more factors, such as, for example, the values of one or more operating parameters of the converter and/or the EFET platform being supplied by the converter or, simply, the status of an on/off switch. If it is determined, in decision block 72, to continue, the operation transfers back functional block 62 and begins a new iteration. If, on the other hand, it is determined, in decision block 72, to continue, the operation concludes by exiting through block 74. It will be appreciated that the flow chart shown in FIG. 6 is intended to be exemplary and that the invention may also be operated with variations of the details shown in the figure.

The need to develop a battery-operated high voltage power supply was driven by four factors, namely:

1) the need for a low cost supply that can operate from a couple of AA alkaline batteries;

2) a need for maximum operating life (especially in table-top EFET fragrance products);

3) the lack of commercial devices that fill these needs; and

4) the shortcomings of our present HVPS design.

Generally, commercially available prior art converters claim much better operating efficiency than has been demonstrated by the present invention; however. these devices have several drawbacks, namely:

a) none are capable of operating with only 2 to 3 Volt DC input and most require at least 9 Volts DC;

b) efficiency figures are presented for maximum load, which is orders of magnitude greater than that required by most EFET aerosolizers; and

c) many of the smaller units to be used in portable designs are not able to generate 10 kV or more; and

d) the cost per unit is prohibitively high, often $100 or more in small quantities for commercially available power supplies.

The present invention overcomes all of the above-listed draw backs of the prior art devices while also satisfying the above-listed needs.

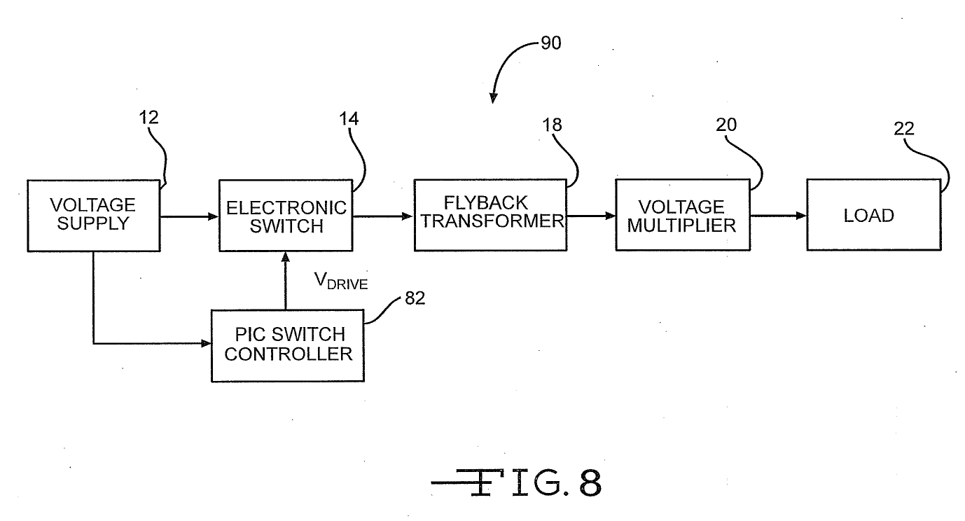

The present invention contemplates an alternate embodiment which is shown generally at 80 in FIG. 7. Components shown in FIG. 7 that are similar to components shown in the other drawings have the same numerical identifiers. In the alternate embodiment 80, the regulation function is implemented with a Microsim PIC 10F220 microprocessor (not shown) 82, or a similar microprocessor, that replaces the switch controller 16 shown in FIG. 1. Additionally, the output voltage form the voltage multiplier 20 is resistively divided to a voltage level compatible with the regulating circuitry and a feedback signal V_{FB}′ representative of the output voltage is delivered to the regulating circuitry 82. The programming of the processor establishes the fixed duration of the conduction period to 8.9 μsec, or to a length appropriate to the flyback transformer being used, and the frequency of pulses is modified based on the value of the feedback signal from the output. In this manner, the output voltage is controlled to a constant value, or set-point, even if the output current drawn by the load varies. Delays inherent in the circuitry typically result in the feedback voltage overshooting the set-point before the drive voltage is shut off The switch remains in a non-conducting state until the output voltage decays sufficiently for the feedback voltage to again reach the set-point, at which time the drive voltage is resumed. Because the cost of the PIC 10F220 is less than the cost of the voltage regulator U1, the alternate embodiment 80 is cheaper than the embodiment 10 shown in FIG. 1.

The present invention also contemplates another alternate embodiment which is shown generally at 90 in FIG. 8. Components shown in FIG. 8 that are similar to components shown in the other drawings have the same numerical identifiers. The regulation function is again implemented with a Microsim PIC 10F220 82 microprocessor (not shown) or similar microprocessor for the switch controller 16 shown in FIG. 1. The alternate embodiment 90 uses a feed forward control technique in that the frequency of the pulses is based on the magnitude of the input power voltage to maintain a nearly constant output voltage value. Thus, as the battery voltage drops with the withdrawal of energy, the time period between charging pulses is reduced. Regulation based strictly on line voltage works well in EFET applications since the spraying process usually draws very little current from the high voltage output and behaves as a constant load.

In accordance with the provisions of the patent statutes, the principle and mode of operation of this invention have been explained and illustrated in its first embodiment. However, it must be understood that this invention may be practiced otherwise than as specifically explained and illustrated without departing from its spirit or scope.

What is claimed is:

1. A high voltage DC to DC power converter comprising:
an electronic switch having an input port adapted to be connected to a power supply, said electronic switch also including an output port and a control port;
a flyback transformer having a primary winding connected to said electronic switch output port, said flyback transformer also having a secondary winding;
a voltage multiplier circuit having an input port connected to said flyback transformer secondary winding, said voltage multiplier circuit also having an output port adapted to be connected to an electrical load; and
a controller for said electronic switch, said controller operative to cause said electronic switch to alternate between conducting and non-conducting states to supply an initial amount of energy to said flyback transformer, said controller being further operative as a function of an operating parameter of the converter to again cause said electronic switch to enter said conducting state to supply additional energy to said flyback transformer.

2. The power converter according to claim 1 wherein said controller includes a voltage regulator circuit and said operating parameter is related to a voltage within said voltage multiplier circuit and further wherein said controller is operative to continue said initial supply of energy to said flyback transformer until said operating parameter reaches a threshold voltage.

3. The power converter according to claim 2 wherein said threshold is a first threshold and further wherein said controller is operative to cause said electronic switch to supply additional energy to said flyback transformer when said operating parameter reaches a second threshold value that is related to hysteresis within said voltage regulator circuit, said second threshold being less than said first threshold.

4. The power converter according to claim 3 wherein said controller causes said electronic switch to alternate between conducting and non-conducting states by applying a train of voltage pulses to said electronic switch control port and further wherein said train of voltage pulses has a nominal frequency of about 40 kHz.

5. The power converter according to claim 4 wherein operation of said electronic switch causes the flyback transformer to alternate between a conduction period having a duration of approximately nine microsecond and a discharge period having a duration of approximately 15 μsec.

6. The power converter according to claim 5 wherein said controller is operable to supply additional energy to said flyback transformer at intervals of approximately 5 milliseconds.

7. The power converter according to claim 6 wherein said voltage multiplier includes a Crokcroft-Walton voltage multiplier circuit.

8. The power converter according to claim 7 wherein said electronic switch is one of a bipolar junction transistor and a field effect transistor with associated buffering circuitry.

9. The power converter according to claim 1 wherein said controller includes a microprocessor and said operating parameter is related to a voltage multiplier output voltage and further wherein said controller is operative to continue said initial supply of energy to said flyback transformer until said operating parameter reaches a set-point value.

10. The power converter according to claim 9 wherein said controller is operative to cause said electronic switch to supply additional energy to said flyback transformer when said operating parameter falls below said set point value and to stop supplying said additional energy when said operating parameter raises above said set-point value.

11. The power converter according to claim 10 wherein said controller causes said electronic switch to alternate between conducting and non-conducting states by applying a train of voltage pulses to said electronic switch control port and further wherein said train of voltage pulses has a nominal frequency of about 40 kHz.

12. The power converter according to claim 11 wherein said voltage multiplier includes a Crokcroft-Walton voltage multiplier circuit.

13. The power converter according to claim 12 wherein said electronic switch is one of a bipolar junction transistor and a field effect transistor with associated buffering circuitry.

14. The power converter according to claim 1 wherein said controller includes a microprocessor and said operating parameter is related to an input voltage supplied by said power supply and further wherein said controller is operative to vary the duration of the intervals between causing said electronic switch to supply additional energy to said flyback transformer as a function of said operating parameter.

15. The power converter according to claim 14 wherein said controller is operable to reduce the duration of the intervals between causing said electronic switch to supply additional energy to said flyback transformer as said operating parameter decreases.

16. The power converter according to claim 15 wherein said voltage multiplier includes a Crokcroft-Walton voltage multiplier circuit.

17. The power converter according to claim 16 wherein said electronic switch is one of a bipolar junction transistor and a field effect transistor with associated buffering circuitry.

18. A method of operating a high voltage DC to DC power converter comprising the steps of:
(a) providing an electronic switch having an input port adapted to be connected to a power supply, the electronic switch also including an output port and a control port with the output port connected to the primary winding of a flyback transformer, the flyback transformer having a secondary winding connected to an input port of a voltage multiplier circuit, the voltage multiplier circuit also having an output port adapted to be connected to an electrical load and a controller for the electronic switch;
(b) causing the electronic switch to enter an operating state in which the switch alternates between conducting and non-conducting states to supply an initial amount of energy to the flyback transformer;
(c) placing the electronic switch in a non-conducting state;
(d) monitoring an operating parameter of the power converter; and
(e) causing the electronic switch to reenter the operating state as a function of the monitored operating parameter.

19. The method according to claim 18 wherein the operating parameter monitored in step (d) is related to one of a voltage multiplier output voltage and an input voltage supplied by the power supply.
